(19) United States
(12) Patent Application Publication
(10) Pub. No.: US 2018/0374010 A1
(43) Pub. Date: Dec. 27, 2018

(54) PREDICTING EARLY WARNING SIGNALS IN PROJECT DELIVERY

(71) Applicant: International Business Machines Corporation, Armonk, NY (US)

(72) Inventors: Kishore B. Burde, Pune (IN); Sankar Ghoshal, Kolkata (IN); Deepak Gupta, Indirapuram (IN); Namita Gupta, Ghaziabad (IN); Soundarya Lahari Kamalapuram, Hyderabad (IN); Lavanya Rajagopalan, Chennai (IN)

(21) Appl. No.: 15/632,464

(22) Filed: Jun. 26, 2017

(51) Int. Cl. G06Q 10/06; G06N 5/02

(52) U.S. Cl. CPC G06Q 10/0635; G06F 17/2818; G06N 5/022

(57) ABSTRACT

The disclosure is directed to project management. A method for predicting early warning signals in project delivery according to embodiments includes classifying data related to a project into a plurality of classes of data, the data including unstructured data related to the project and structured data related to the project; inputting each of the plurality of classes of data into a cognitive engine for predictive analysis, the cognitive engine outputting a prediction value for each of the plurality of classes; applying a weighting to each of the prediction values outputted by the cognitive engine; combining the weighted prediction values; and predictively outputting an early warning signal based on the combination of weighted prediction values.

### TECHNICAL FIELD

The present invention relates generally to project management, and more particularly, to a method, system, and computer program product for predicting early warning signals of trouble in project delivery.

### BACKGROUND

Many projects, especially complex projects, do not behave as anticipated. In practice, an unacceptable number of projects require rework, fail outright, or even if successful, do not provide a return on investment. As a result, significant losses may be incurred by an organization due to loss of revenue, or due to the loss of current or future projects to competitors. Much of the failure of a project can be attributed to project management.

A project generally does not go from “green” to “red” overnight. There may be early warning signals, but these are typically overlooked or misunderstood. Many project managers do not know when or how to raise a red flag when an early warning signal is identified. That is, many project managers do not have enough expertize to realize that a project is headed for trouble and wait too long to reach out to others involved with the project for assistance. Unfortunately, the longer it takes for corrections to be made to a project, the costlier such corrections and the overall project become.

A project audit performed by an independent quality review team may be used to detect early warning signals in a project. More commonly however, early warning signals are identified based on the “gut feeling” of a project manager or the auditor or other person working on or involved in the project.

These mechanisms have obvious drawbacks in terms of the cost of the review, the cost to the project, and the delay to the project. Further, these mechanisms are generally unreliable and inconsistent, often failing to identify issues in a project. These issues can no longer be sustained for a number of reasons, including, for example: increased complexity of projects; smaller profit margins; shorter time to completion in today's rapidly evolving market; reduction in governance; and less reliance on manual involvement.

### SUMMARY

A first aspect of the invention provides a method for predicting early warning signals in project delivery, including: classifying data related to a project into a plurality of classes of data, the data including unstructured data related to the project and structured data related to the project; inputting each of the plurality of classes of data into a cognitive engine for predictive analysis, the cognitive engine outputting a prediction value for each of the plurality of classes; applying a weighting to each of the prediction values outputted by the cognitive engine; combining the weighted prediction values; and predictively outputting an early warning signal based on the combination of weighted prediction values.

A second aspect of the invention provides a computerized system for predicting early warning signals in project delivery by performing a method, the method including: classifying data related to a project into a plurality of classes of data, the data including unstructured data related to the project and structured data related to the project; inputting each of the plurality of classes of data into a cognitive engine for predictive analysis, the cognitive engine outputting a prediction value for each of the plurality of classes; applying a weighting to each of the prediction values outputted by the cognitive engine; combining the weighted prediction values; and predictively outputting an early warning signal based on the combination of weighted prediction values.

A third aspect of the invention provides a computer program product stored on a computer readable storage medium, which when executed by a computer system, performs a method for predicting early warning signals in project delivery, the method including: classifying data related to a project into a plurality of classes of data, the data including unstructured data related to the project and structured data related to the project; inputting each of the plurality of classes of data into a cognitive engine for predictive analysis, the cognitive engine outputting a prediction value for each of the plurality of classes; applying a weighting to each of the prediction values outputted by the cognitive engine; combining the weighted prediction values; and predictively outputting an early warning signal based on the combination of weighted prediction values.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description taken in conjunction with the accompanying drawings that depict various aspects of the invention.

FIG. 1 depicts a system for predicting early warning signals in project delivery according to embodiments.

FIG. 2 depicts a portion of the system for predicting early warning signals in project delivery of FIG. 1 according to embodiments.

FIG. 3 depicts a processing system for predicting early warning signals in project delivery according to embodiments.

FIG. 4 depicts a process according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The present invention relates generally to project management, and more particularly, to a method, system, and program product for predicting early warning signals in project delivery.

According to embodiments, multiple sources of data associated with a project are divided into classes according to type of information (static or dynamic), structure of information (structured or unstructured), nature of information (cumulative or point in time), influence on currency (historic or current information), and relevance depending on phase of the project (transition/project initiation/steady state, etc.). Predictive analytics (e.g., using IBM Watson) and statistical analysis (e.g., using Statistical Package for the Social Sciences (SPSS)) are utilized to analyze the data for signs of trouble, apply predictive models, and derive the probability of projects that carry early warning signals based on the values of the input data—with due consideration to the influence these parameters have on the health of the project and results of repeated application of the same in prediction. Subsequently, the results are integrated using weightages to determine the overall probability of each of the projects going red.

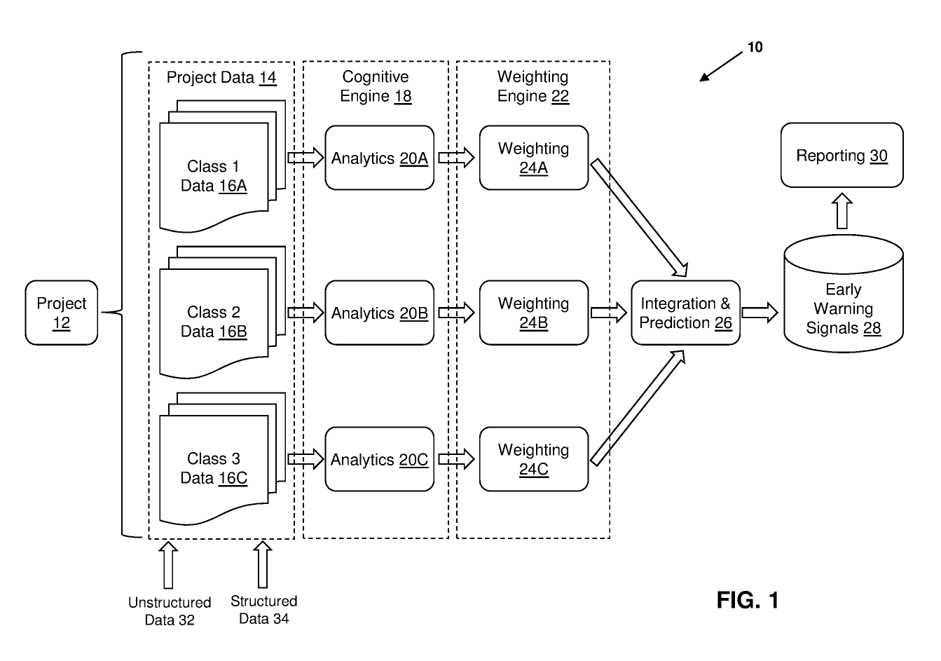

A system 10 for predicting and generating early warning signals 28 in the delivery of a project 12 according to embodiments is depicted in FIG. 1. In general, a wide variety of types of data (project data 14) related to the project 12 is classified into a plurality of different classes of data 16. In the system 10 depicted in FIG. 1, for example, the project data 14 is split into class I data 16A, class II data 16B, and class III data 16C, each of which will be presented in greater detail below.

The different classes of project data 14 (i.e., class I data 16A, class II data 16B, and class III data 16C) is provided to a cognitive engine 18, which includes a plurality of predictive analytic engines 20 for applying predictive analytics to each class of data 16. According to embodiments, different types of predictive analytics may be applied using predictive analytic engines 20A, 20B, and 20C to the class I data 16A, class II data 16B, and class III data 16C, respectively. In other embodiments, the same or similar predictive analytics may be applied by the predictive analytic engines 20A, 20B, and 20C to some or all of the different classes of data 16.

A weighting engine 22 subsequently applies a weighting to the outputs (e.g., prediction values) of the predictive analytic engines 20A, 20B, and 20C of the cognitive engine 18. For example, according to embodiments, a different weighting 24A, 24B, 24C may be applied to each of the outputs of the predictive analytic engines 20A, 20B, 20C. In other embodiments, the same or similar weighing 24 may be applied to the outputs of some or all of the different predictive analytic engines 20. The weighted data output by the weighting engine 22 is input into an integration and prediction engine 26, which is configured to combine and analyze the weighted data and, based thereon, predictively output early warning signals 28 associated with the project 12. The early warning signals 28 may be provided to one or more entities by a reporting system 30.

According to embodiments, the project data 14 includes both unstructured data 32 and structured data 34. The unstructured data 32 and structured data 34 may be obtained, for example, from various sources and repositories associated with the project 12.

Unstructured data 32 associated with the project 12 is collected from various organization sources. One type of unstructured data 32 may include, for example, risks (an event that has not happened yet) and issues (something that already has happened) associated with the project 12. A project management program such as IBM's Program Work Center™ may be used to collect and log the risks and issues associated with the project 12.

Other types of unstructured data 32 may include, for example, review reports (e.g., software quality assurance (SQA) reports), transition reports (e.g., from stage to stage of a project), status reports (e.g., from a project control book), meeting minutes, governance comments, and/or the like. Advantageously, the unstructured data 32, which has heretofore not been utilized for the generation of early warning signals for a project, provides a unique insight into the “true” health of a project that is otherwise not available from other sources of data.

Structured data 34 is typically collected and stored in one or more repositories of an organization. Such structured data 34 may include, for example, project attributes, project launch data, self-assessment red-amber-green (RAG) ratings, quality data including metrics, project financials, and/or the like. Project attributes may include, for example, technology, region, complexity, risk rating, sector/industry, service line (e.g., grouping of products and services), city/country of the client, city/country of the delivery center, if there are multiple delivery centers involved, multi-vendor data, delivery methodology, type of project, nature of work, contract type, etc.

The project data 14, both unstructured data 32 and structured data 34, is subsequently classified into a number of classes 16 for prediction. For example, the project data 14 may be classified into class I data 16A, class II data 16B, and class III data 16C, each of which are described below.

According to embodiments, the class I data 16A includes unstructured data 32 with insights on project issues, risks, dependencies, and assumptions. The class I data 16A is dynamic data and cumulative in nature. As an example, class I data 16A may include issues and risks, review reports, status reports, governance comments, meeting minutes, action items from reviews, audio, visual images, videos, and/or the like. Transition reports and project launch data may be included for new projects (e.g., based on start date, transition status, etc.).

According to embodiments, the class II data 16B includes standard project attributes that influence complexity and risk rating. Class II data 16B includes mostly static data (unless contractual changes are initiated). As an example, class II data 16B may include project attributes such as technology, region, complexity, risk rating, sector/industry, service line, geography data of client and delivery center, multiple delivery centers, multi-vendor data, delivery methodology, type of project, nature of work, contract type, etc.

According to embodiments, the class III data 16C includes project performance data (e.g., current project status). Class III data 16C is dynamic data, but point in time (i.e., not cumulative). As an example, class III data 16C may include metrics data (e.g., schedule and effort variance, defect density data, service level agreement (SLA) performance, velocity, etc.), RAG rating of reviews, compliance to organization's standard processes, methods & tools, project financial performance, key performance indicator (KPI) data from status reports, RAG rating pattern, action item process area mapping, and/or the like.

Additional data may be included in one or more of the classes of data based, for example, on time and project phase. For example, during transition, transition review reports may be integrated into class I data, while during project initiation, project launch data may be integrated into class III data.

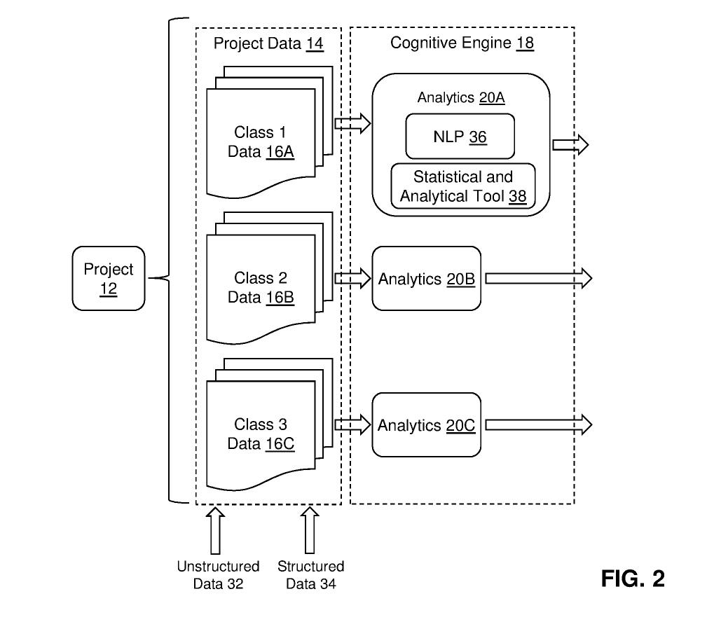

The class I data 16A, class II data 16B, and class III data 16C are passed through respective predictive analytic engines 20A, 20B, 20C in the cognitive engine 18 as illustrated in FIGS. 1 and 2. According to embodiments, the class I data 16A, which includes unstructured data 32, is passed through a predictive analytics engine 20A (e.g., IBM Watson Engine), which applies two layers of analytics to the class I data 16A. One layer of analytics is provided by passing the class I data 16A through a natural language processing (NLP) engine 36. The natural language processing engine 36 analyzes the structure and meaning of the class 1 data 16A for product related information such as concepts, entities, keywords, sentiment, and/or the like. The output of the natural language processing engine 36 is then analyzed using a predictive model (e.g., provided via IBM Watson) to forecast the probability of project trouble. The output of the predictive engine 20A may be passed through a second layer of analytics that is also configured to determine the probability of early warning or project trouble. The second layer of analytics may be provided by passing the output of the natural language processing engine 36 through a statistical and analytical model 38 (e.g., provided by SPSS), that is also configured to determine the probability of early warning or project trouble.

The class II data 16B is primarily structured data and is passed through the predictive analytics engine 20B (e.g., IBM Watson Engine) to determine a probability of project trouble. The class III data 16C is passed through the predictive analytics engine 20C (e.g., IBM Watson Engine) to determine a probability of project trouble. In embodiments, the predictive analytics engines 20B and 20C apply different predictive models (e.g., based on the content/type of the class II data 16B and the class III data 16C and its relationship with past projects).

The predictive models used in the predictive analytics engines 20A, 20B, 20C may be determined based, for example, on the type of data being analyzed, the accuracy of the predictive model (e.g., learning as it goes), and the results output by the predictive model. Available tools (e.g., IBM Watson) may provide multiple different predictive models. Once the data is provided for learning, the output and inputs for each predictive model are defined. The tool applies various predictive models individually, or a combination of predictive models, and checks which combination provides the most accurate results. It then trains itself to use that model for future. The tool re-trains and re-adjusts each predictive model when more results are provided over a period of time.

The predictive analytic engines 20A, 20B, and 20C of the cognitive engine 18 are trained using past project information (e.g., for N previous years). The past project information may include project data for projects that were troubled, failed, or went into early warning, as well as project data associated with successful projects. For example, 3 years of past project data may be appropriate, although a higher or lower number of years of data may be utilized as necessary. The past project information may include project data divided as detailed above into class I data 16A, class II data 16B, and class III data 16C. Further, lists of the root causes for projects that were troubled, failed, or went into early warning, may be provided for training purposes.

A weighting engine 22 applies a weighting to the outputs (e.g., prediction values) of the predictive analytic engines 20A, 20B, and 20C of the cognitive engine 18. According to embodiments, the weighting may, for example, be based on the number of previous projects correctly identified as troubled using the different classes of data. For instance, the weighting of the prediction values corresponding to the class I data 16A may be higher than the weighting of the prediction values for the other classes of data if a greater number of troubled projects have been identified using the class I data 16A compared to the class II data 16B and class III data 16C. Other weighting schemes, however, may also be used.

The weighted data output by the weighting engine 22 is input into an integration and prediction engine 26, which is configured to combine and analyze the weighted data and, based thereon, predictively output early warning signals 28 associated with the project 12. The early warning signals 28 may be provided to one or more entities by a reporting system 30. The reporting system 30 may use any suitable type of process (e.g., email, text messages, etc.) to provide the early warning signals 28 to the appropriate personal.

The early warning signals 28 and a list of projects that were correctly predicted as being troubled (or heading for trouble) may be fed back to the cognitive engine 18. The cognitive engine 18 may use this data to further train the predictive models used by the predictive analytics engines 20A, 20B, and 20C, to adjust the weightages applied by the weighting engine 22, or for any other suitable purpose.

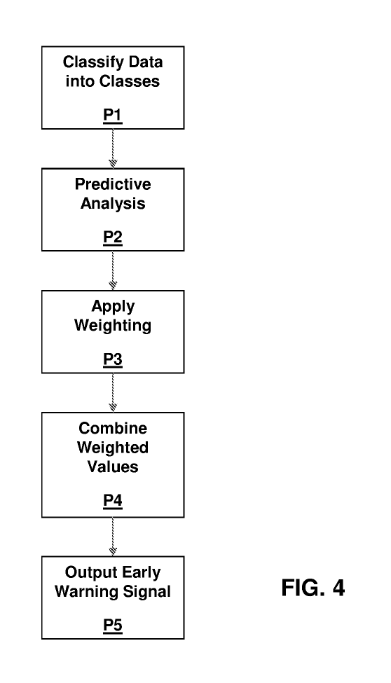

FIG. 4 depicts a process for predicting early warning signals in project delivery according to embodiments. At P1, data related to a project is classified into a plurality of classes of data, the data including unstructured data related to the project and structured data related to the project. At P2, each of the plurality of classes of data is inputted into a cognitive engine for predictive analysis, the cognitive engine outputting a prediction value for each of the plurality of classes. At P3, a weighting is applied to each of the prediction values outputted by the cognitive engine. At P4, the weighted prediction values are combined. At P5, an early warning signal is predictively outputted based on the combination of weighted prediction values.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

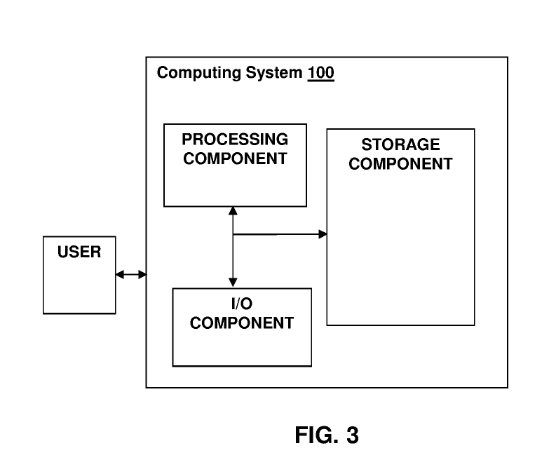

FIG. 3 depicts an illustrative processing system 100 (e.g., within a mobile device) for implementing the present invention, according to embodiments. The processing system 100 may comprise any type of computing device and, and for example includes at least one processor, memory, an input/output (I/O) (e.g., one or more I/O interfaces and/or devices), and a communications pathway. In general, processor(s) execute program code, which is at least partially fixed in memory. While executing program code, processor(s) can process data, which can result in reading and/or writing transformed data from/to memory and/or I/O for further processing. The pathway provides a communications link between each of the components in processing system 100. I/O can comprise one or more human I/O devices, which enable a user to interact with processing system 100.

The various embodiments discussed herein can offer several technical and commercial advantages, some of which are discussed herein by way of example. Embodiments of the present disclosure can eliminate the deficiencies suffered by the reactive network bandwidth balancing techniques employed by the prior art. Furthermore, embodiments of the method discussed herein can be used to automatically balance network bandwidth to minimize the over/under subscribing of network resources.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A method for predicting early warning signals in project delivery, comprising:
classifying data related to a project into a plurality of classes of data, the data including unstructured data related to the project and structured data related to the project;
inputting each of the plurality of classes of data into a cognitive engine for predictive analysis, the cognitive engine outputting a prediction value for each of the plurality of classes;
applying a weighting to each of the prediction values outputted by the cognitive engine;
combining the weighted prediction values; and
predictively outputting an early warning signal based on the combination of weighted prediction values.

2. The method according to claim 1, wherein the plurality of classes of data includes class I data, class II data, and class III data, and wherein the cognitive engine includes a first predictive analytic engine for generating a prediction value for the class I data, a second predictive analytic engine for generating a prediction value for the class II data, and a third predictive analytic engine for generating a prediction value for the class III data.

3. The method according to claim 2, wherein the class I data includes the unstructured data, and wherein the class I data includes dynamic and cumulative data.

4. The method according to claim 3, wherein the class I data includes at least one of project issues and risks, project review reports, project status reports, project governance comments, project meeting minutes, and action items from reviews of the project.

5. The method according to claim 3, wherein the first predictive analytic engine includes a natural language processing engine and a statistical and analytical engine for predictively analyzing the class I data.

6. The method according to claim 2, wherein the class II data includes a first portion of the structured data, the first portion of the structured data comprising static project attributes.

7. The method according to claim 6, wherein the class III data includes a second portion of the structured data, the second portion of the structured data comprising dynamic project performance data.

8. The method according to claim 1, further including training the cognitive engine using past project information.

9. The method according to claim 8, wherein the cognitive engine is trained using past project information for previous projects that were troubled, failed, or went into early warning.

10. A computerized system for predicting early warning signals in project delivery by performing a method, the method comprising:
classifying data related to a project into a plurality of classes of data, the data including unstructured data related to the project and structured data related to the project;
inputting each of the plurality of classes of data into a cognitive engine for predictive analysis, the cognitive engine outputting a prediction value for each of the plurality of classes;
applying a weighting to each of the prediction values outputted by the cognitive engine;
combining the weighted prediction values; and
predictively outputting an early warning signal based on the combination of weighted prediction values.

11. The computerized system according to claim 10, wherein the plurality of classes of data includes class I data, class II data, and class III data, wherein the class I data includes the unstructured data, wherein the class I data includes dynamic and cumulative data, wherein the class II data includes a first portion of the structured data, the first portion of the structured data comprising static project attributes, and wherein the class III data includes a second portion of the structured data, the second portion of the structured data comprising dynamic project performance data.

12. The computerized system according to claim 11, wherein the class I data includes at least one of project issues and risks, project review reports, project status reports, project governance comments, project meeting minutes, and action items from reviews of the project.

13. The computerized system according to claim 11, the method further comprising predictively analyzing the class I data using a predictive analytic engine including a natural language processing engine and a statistical and analytical engine.

14. A computer program product stored on a computer readable storage medium, which when executed by a computer system, performs a method for predicting early warning signals in project delivery, the method including:
classifying data related to a project into a plurality of classes of data, the data including unstructured data related to the project and structured data related to the project;
inputting each of the plurality of classes of data into a cognitive engine for predictive analysis, the cognitive engine outputting a prediction value for each of the plurality of classes;
applying a weighting to each of the prediction values outputted by the cognitive engine;
combining the weighted prediction values; and
predictively outputting an early warning signal based on the combination of weighted prediction values.

15. The computer program product according to claim 14, wherein the plurality of classes of data includes class I data, class II data, and class III data, and wherein the cognitive engine includes a first predictive analytic engine for generating a prediction value for the class I data, a second predictive analytic engine for generating a prediction value for the class II data, and a third predictive analytic engine for generating a prediction value for the class III data.

16. The computer program product according to claim 14, wherein the class I data includes the unstructured data, and wherein the class I data includes dynamic and cumulative data, and wherein the class I data includes at least one of project issues and risks, project review reports, project status reports, project governance comments, project meeting minutes, and action items from reviews of the project.

17. The computer program product according to claim 14, wherein the first predictive analytic engine includes a natural language processing engine and a statistical and analytical engine for predictively analyzing the class I data.

18. The computer program product according to claim 14, wherein the class II data includes a first portion of the structured data, the first portion of the structured data comprising static project attributes.

19. The computer program product according to claim 18, wherein the class III data includes a second portion of the structured data, the second portion of the structured data comprising dynamic project performance data.

20. The computer program product according to claim 13, further including training the cognitive engine using past project information, wherein the cognitive engine is trained using past project information for previous projects that were troubled, failed, or went into early warning.
